(19) United States
(12) Patent Application Publication
(10) Pub. No.: US 2004/0239825 A1
(43) Pub. Date: Dec. 2, 2004

(54) Liquid crystal device, active matrix substrate, display device, and electronic equipment

(75) Inventors: Shin Koide, Chino-shi (JP); Tomoyuki Ito, Okaya-shi (JP); Takeshi Koshihara, Nagano-shi (JP); Atsushi Kitagawa, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/825,301

(22) Filed: Apr. 16, 2004

(30) Foreign Application Priority Data
May 16, 2003 (JP) 2003-139205

(51) Int. Cl. G02F 1/136

(52) U.S. Cl. 349/42

(57) ABSTRACT

To provide a liquid crystal device capable of controlling leakage current of a thin-film transistor to an extremely low level, making it easy to achieve extra-high definition of pixels, and to provide electronic equipment having the liquid crystal device, a liquid crystal device includes a TFT of a P-type transistor having a semiconductor layer formed of polysilicon, and a plurality of gate electrodes that intersect with the semiconductor layer at a plurality of locations. The liquid crystal device has an LDD structure in which lightly doped regions are formed on both sides of each channel region of the semiconductor layer. A light shielding device (a light shielding film and a data line branched portion) are provided on both sides in the direction of the thickness of the thin-film transistor.

### BACKGROUND OF THE INVENTION

1. Field of Invention

The present invention relates to an active matrix substrate, a liquid crystal device, a display device, and electronic equipment.

2. Description of Related Art

There is high demand for higher luminance and definition in the field of display devices, including liquid crystal devices. For instance, with the current increasingly accelerating digitization of photographs, there has been growing need for development of display devices producing images that are as sharp as conventional photographs without printing.

However, liquid crystal panels having extra-high definition have not yet been achieved by the related art, mainly because leakage current of transistors used for pixels has not been reduced.

There have been methods to produce a semiconductor layer of a thin-film transistor of a liquid crystal device by amorphous silicon, low-temperature polysilicon films or high-temperature polysilicon films. A method using low-temperature polysilicon films is advantageous in that image signal supplying circuits can be formed around pixels and larger glass substrates can be used. This method may be most promising to achieve liquid crystal panels with extra-high definition in such an aspect. However, low-temperature polysilicon films include many defects therein, usually leading to high leakage current values. The leakage current shows a highest value from among the aforesaid three methods. In this respect, this method is unsuitable to achieve liquid crystal panels with extra-high definitions. This method exhibits the contradictory aspects.

An example of a liquid crystal display device of a 200 ppi-class (200 pixels per 25.4 mm) known as feature high definition in the related art uses N-type transistors for pixels, employs LDD type junction similar to an LSI technology, and adopts a multi-gat structure in which a gate is divided into two or three stages.

Methods to reduce leakage current include a method using P type known to have relatively low leakage current in a dark condition (see Japanese Unexamined Patent Application Publication No. 5-313195) and a method using a light shielding film to reduce optical leakage current that increases in response to light irradiation (see Japanese Unexamined Patent Application Publication No. 3-80225).

### SUMMARY OF THE INVENTION

However, the present inventors actually made liquid crystal devices using related art for low-temperature polysilicon, P-type transistors for pixels, the LDD structure and the multi-gate structure, and a light-shielding structure to block light. The devices showed leakage current values that are not particularly different from those of devices constructed in a similar manner, using N-type transistors. This has revealed that the technologies disclosed in the above documents alone cannot achieve a target reduced value of leakage current required to achieve extra-high definition.

The present invention has been made to address the above problems, and provides a liquid crystal device capable of reduced leakage current of a thin-film transistor to an extremely low level, making it easy to achieve extra-high definition of pixels, and electronic equipment provided with the liquid crystal device.

The present invention also provides an active matrix substrate capable of reduced leakage current of a thin-film transistor to an extremely low level, and a display device provided with the active matrix substrate.

To these ends, a liquid crystal device in accordance with an aspect of the present invention is a liquid crystal device equipped with an active matrix substrate having a plurality of scanning lines and a plurality of data lines provided such that they intersect each other, thin-film transistors provided in association with intersections of the data lines and the scanning lines, and pixel electrodes connected to the thin-film transistors, an opposing substrate disposed such that it opposes the active matrix substrate, and a liquid crystal layer sandwiched between the two substrates. The thin-film transistors are formed of P-type transistors having semiconductor layers, a plurality of gate electrodes intersecting the semiconductor layers at a plurality of locations, LDD portions in which P-type lightly doped regions are formed at least on one side of channel regions of the semiconductor layers, and a light shielding device is provided on both sides in the direction of thickness of the thin-film transistors.

Close investigation into a cause for the P-type transistors and the N-type transistors showing the similar level of leakage current, hinted that leakage current increases in response to slight light entering a semiconductor layer through a gap of a light shielding film. Then, the present inventors precisely checked leakage current Ids by applying different quantities of light and different drain-source voltage Vds of the N-type transistors and the P-type transistors. As a result, the characteristics shown in FIG. 10 and FIG. 11 have been obtained.

FIG. 10 and FIG. 11 show charts in which the axes of ordinate indicate drain-source current Ids, i.e., leakage current Ids, observed when an OFF gate voltage Vgs is applied, while the axes of abscissa indicate drain-source voltage Vds. The charts plot dark current of a transistor in the absence of light shielding film and values obtained when light is incident upon a surface on the opposite side from a gate electrode. A surface light source having the light intensity (unit: Cd/m²) shown in the charts was brought into direct contact with a glass substrate, on which the thin-film transistor has been formed, to perform measurement so as to obtain the data.

As can be seen from the charts, the leakage current of the P-type transistor is certainly small under a dark condition. However, it is understood that applying slight light causes the P-type transistor to develop as much leakage current as that of the N-type transistor. This trend can be reduced by a multi-gate, because the voltage between the drain and the source is divided into a few stages. The trend being particularly marked in a low-voltage range in which the drain-source voltage Vds lies in the range of about 0 to about 5V. According to a presumption based on a semiconductor theory, the cause is reasonably considered to result from properties of electrons, which are minority carriers of the P-type, because current characteristics depend on minority carriers in an OFF state. Using multiple gates, i.e., a multi-gate, makes it possible to reduce the drain-source voltage Vds applied per TFT among a plurality of TFTs. This leads to reduced leakage current (dark current) under a dark condition. However, the susceptibility of leakage current to applied light is abnormally high in the voltage range, the drain-source voltage Vds being low because of the reason explained in conjunction with FIG. 10 or FIG. 11. This means that even though the drain-source voltage Vds is reduced by adopting the multi-gate, a small quantity of light entering the semiconductor layer leads to an increased leakage current of the transistor, thus canceling the advantage obtained by using the LDD P-type.

Hence, the present inventors have decided to employ the LDD and the multi-gate and to provide a light shielding device on the top and bottom of the semiconductor layer to reduce or prevent light from entering the semiconductor layer as much as possible instead of only using P-type transistors for pixels as in the related art. This has allowed the characteristics of low OFF current inherent in the P-type. The construction has made it possible to achieve a reduction in leakage current by one order or more, as compared with a case where the N-type is used.

It has been made possible to accomplish a thin-film transistor type liquid crystal display device of 500 ppi or more, which indicates desired photographic image quality, by using a low temperature polysilicon technology that allows an image signal supplying circuit to be configured around pixels and also by effectively using the P-type in the configuration according to the related art.

The liquid crystal device in accordance with an aspect of the present invention can be configured such that the data lines are disposed to planarly overlap channel regions of the semiconductor layer so as to form the light shielding device. With this arrangement, the data lines are utilized as the light shielding device for the thin-film transistors, so that brighter display can be obtained by increasing the aperture ratios of pixels.

The liquid crystal device in accordance with an aspect of the present invention has the data lines that include data line mainline portions extending in a direction in which they intersect the scanning lines and data line branched portions branched or extended from the data line mainline portions in a direction in which they intersect the data line mainline portions. The data line branched portions are disposed such that they planarly overlap the channel regions so as to form the light shielding device.

The liquid crystal device in accordance with an aspect of the present invention can be also configured such that a reflective layer is formed on the active matrix substrate to perform reflective display. A part of the reflective layer is formed to planarly overlap channel regions of the semiconductor layers so as to constitute the light shielding device. This arrangement makes it possible to provide a reflective or transflective liquid crystal device that permits leakage current of thin-film transistors to be reduced to an extremely low level and also permits display with higher definition to be achieved. There is an additional advantage in that manufacture can be simplified, since the light shielding device is formed by a part of a reflective layer.

The liquid crystal device in accordance with an aspect of the present invention can be also configured such that the scanning lines have scanning line mainline portions extending in a direction in which they intersect the data lines, and a plurality of scanning line branched portions extended in a direction in which they intersect the scanning line mainline portions. The scanning line branched portions have a plurality of gate electrodes that planarly intersect the semiconductor layers. With this arrangement, multi-gate thin-film transistors can be constructed relatively easily, and an increase in electrical resistance due to routing of wires can be restrained.

In the liquid crystal device in accordance with an aspect of the present invention, the semiconductor layers may be formed of polysilicon or continuous grain silicon.

The liquid crystal device in accordance with an aspect of the present invention can be also configured such that the light shielding device is formed on the opposing substrate at a position corresponding to the channel regions. This arrangement also permits efficient light shielding of thin-film transistors, and makes it possible to utilize the characteristic of low OFF current inherent in the P-type transistors.

An active matrix substrate in accordance with an aspect of the present invention includes a plurality of scanning lines and a plurality of data lines provided such that they intersect each other, and thin-film transistors provided in association with intersections of the data lines and the scanning lines. The thin-film transistors are formed of P-type transistors having semiconductor layers, a plurality of gate electrodes intersecting the semiconductor layers at a plurality of locations, LDD portions in which P-type lightly doped regions are formed at least on one side of channel regions of the semiconductor layers, and a light shielding device is provided on both sides in the direction of thickness of the thin-film transistors.

In this active matrix substrate, the LDD and the multi-gate are used, and the light shielding device is provided on the top and bottom of the semiconductor layers to prevent light from entering the semiconductor layer as much as possible, instead of merely using P-type transistors for pixels. This has allowed the characteristics of low OFF current inherent in the P-type to be utilized. The construction has made it possible to achieve a reduction in leakage current by one order or more, as compared with a case where the N-type is used.

The active matrix substrate in accordance with an aspect of the present invention is an active matrix substrate ideally used particularly with a display device of extra-high definition of 500 ppi or more. The active matrix substrate can be ideally used as a major component of, for example, a liquid crystal device, an EL device, a DMD (digital mirror device), a device using fluorescence by plasma emission, electron emission, etc.

The active matrix substrate according to an aspect of the present invention can be configured such that the data lines are disposed to planarly overlap the channel regions of the semiconductor layers so as to form the light shielding device.

The active matrix substrate according to an aspect of the present invention can be also constructed such that the data lines have data line mainline portions extending in a direction in which they intersect the scanning lines, and data line branched portions branched or extended from the data line mainline portions in a direction in which they intersect the data line mainline portions. The data line branched portions are disposed such that they planarly overlap the channel regions so as to form the light shielding device.

The above arrangement makes it possible to provide a high-definition active matrix substrate with a high aperture ratio.

In the active matrix substrate in accordance with an aspect of the present invention, the semiconductor layers may be formed of polysilicon or continuous grain silicon.

The display device in accordance with an aspect of the present invention provides an active matrix substrate in accordance with an aspect of the present invention previously described. This arrangement makes it possible to achieve higher definition of a display device for a liquid crystal device, an EL device, a DMD (digital mirror device), a device using fluorescence by plasma emission, electron emission, etc.

The electronic equipment in accordance with an aspect of the present invention provides a liquid crystal device in accordance with an aspect of the present invention previously described. This arrangement makes it possible to provide electronic equipment having a display unit that permits high-definition display to be achieved. For example, a projection type display device with high image quality capable of high-definition display can be provided by combining a light source, the aforementioned liquid crystal device adapted to modulate light emitted from the light source so as to obtain image light, and a projection optical system adapted to enlarge and project the image light emitted from the liquid crystal device.

### BRIEF DESCRIPTION OF THE DRAWINGS

FIG. 1(a) is a top plan view of a liquid crystal device according to a first exemplary embodiment, and FIG. 1(b) is a sectional schematic taken along plane H-H shown in FIG. 1(a);

FIG. 2 is a circuit schematic of the liquid crystal device;

FIG. 3 is a schematic showing one pixel region of the liquid crystal device;

FIG. 4 is a sectional schematic taken along plane A-A′ shown in FIG. 3;

FIG. 5 is a schematic showing one pixel region according to a second exemplary embodiment;

FIG. 6 is a sectional schematic taken along plane B-B′ shown in FIG. 5;

FIG. 7 is a schematic showing one pixel region according to a third embodiment;

FIG. 8 is a sectional schematic taken along plane C-C′ shown in FIG. 7;

FIG. 9 is a graph showing an operation obtained by introducing an LDD structure;

FIG. 10 is a graph showing photoelectric current characteristics of a P-type transistor;

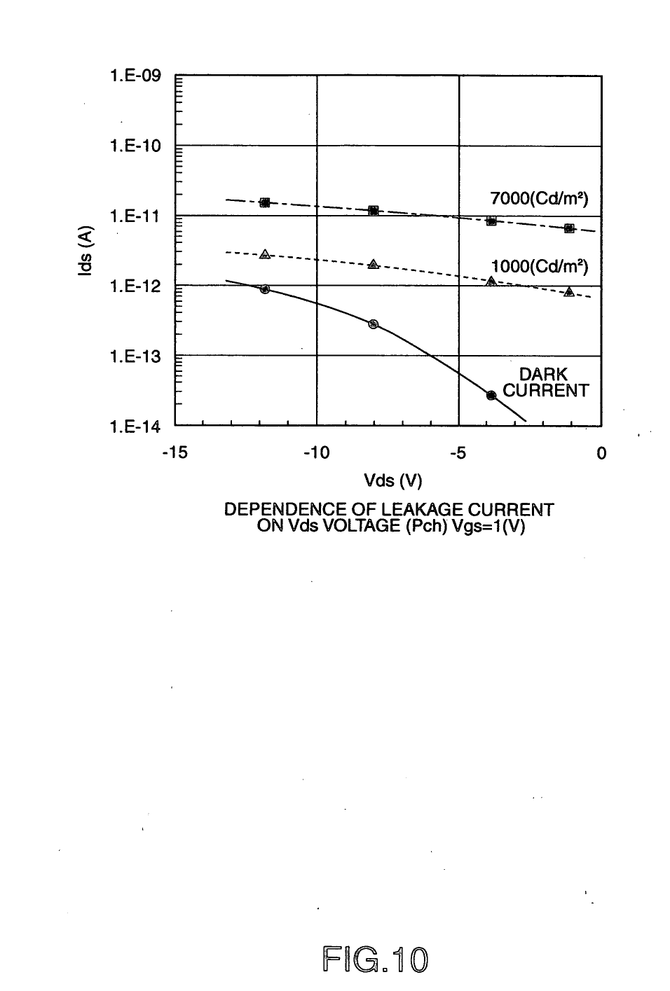

FIG. 11 is a graph showing photoelectric current characteristics of an N-type transistor; and

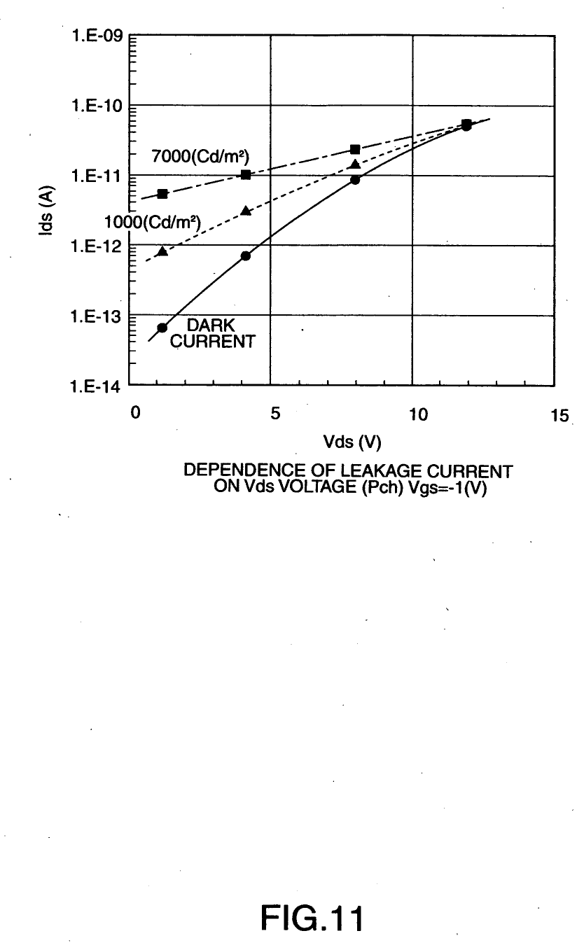

FIG. 12 is a schematic of a projection type display device in accordance with an aspect of the present invention.

### DETAILED DESCRIPTION OF EXEMPLARY EMBODIMENTS

First Exemplary Embodiment

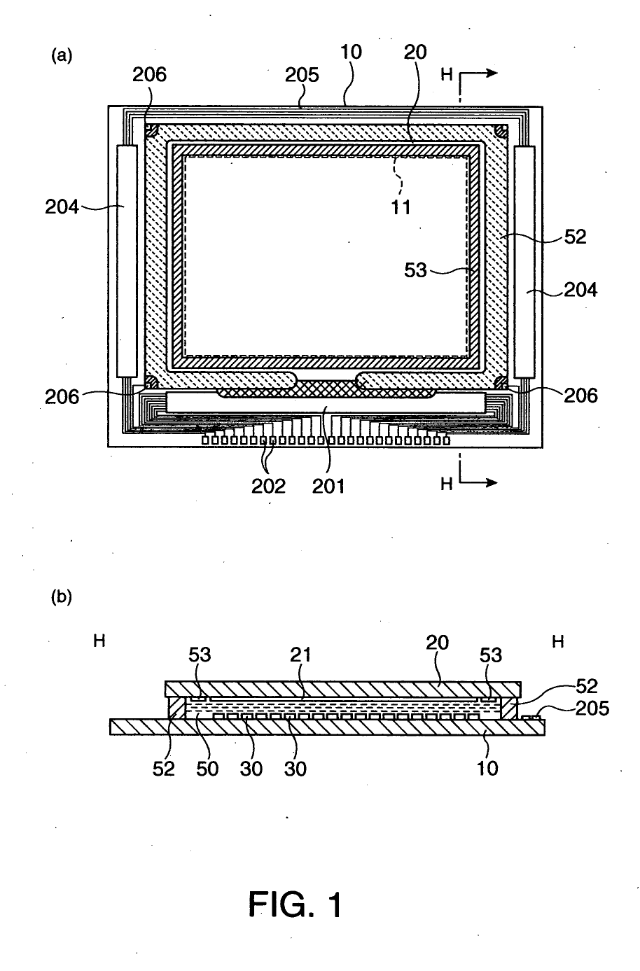

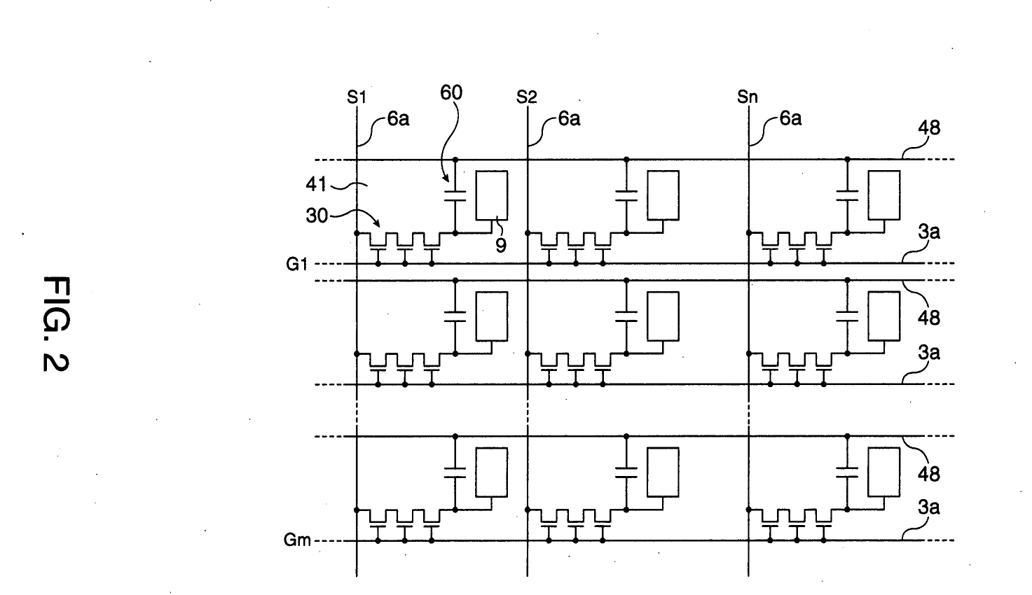

A first exemplary embodiment of the present invention will be explained in conjunction with the accompanying drawings. FIG. 1(a) is a schematic of a liquid crystal device according to the present exemplary embodiment, components thereof being observed from the opposing substrate side. FIG. 1(b) is a sectional schematic taken along plane H-H shown in FIG. 1(a). FIG. 2 is a circuit schematic in a plurality of pixels arranged in a matrix pattern in a display region of the liquid crystal device.

As shown in FIG. 1(a) and FIG. 1(b), the liquid crystal device according to the present exemplary embodiment has a TFT array substrate (active matrix substrate) 10 and an opposing substrate 20 that are bonded to each other by a sealing member 52 substantially shaped like a rectangular frame, as observed from above. A liquid crystal layer 50 is sealed in the region encompassed by the sealing member 52. A peripheral parting 53 shaped like a rectangular frame, as observed from above, is formed along the inner periphery of the sealing member 52. The region inside the peripheral parting is defined as an image display region 11. In the region outside the sealing member 52, and a data line drive circuit 201 and external circuit mounting terminals 202 are formed along one side (the bottom side in the figure) of the TFT array substrate 10. Scanning line drive circuits 204 and 204 are formed along the two sides adjacent to the one side. The remaining one side (the top side in the figure) of the TFT array substrate 10 has a plurality of wires 205 connecting the scanning line drive circuits 204 and 204 on both sides of the image display region 11. The four corners of the opposing substrate 20 have inter-substrate conducting members 206 to provide electrical conduction between the TFT array substrate 10 and the opposing substrate 20. The liquid crystal device according to the present exemplary embodiment is constructed as a transmissive liquid crystal device adapted to modulate light from a light source (not shown) disposed on the TFT array substrate 10 and to emit the modulated light from the opposing substrate 20.

The data line drive circuit 201 and the scanning line drive circuits 204 and 204 formed on the TFT array substrate 10 may be replaced by, for example, a COF (Chip On Film) substrate with a drive LSI mounted thereon and a group of terminals formed around the TFT array substrate 10 that are electrically and mechanically connected through the intermediary of an anisotropic conductive film. In the liquid crystal device, a retardation film, a polarizer, etc. are disposed in predetermined orientations, depending on a liguid crystal used threfor, that is, an operation mode, such as a TN (Twisted Nematic) mode, an STN (Super Twisted Nematic) mode, or a homeotropic alignment mode, or normally white mode or normally back mode, which are not shown.

In the image display region of the liquid crystal device having the structure described above, plural pixel regions 41 are arranged in a matrix pattern, as shown in FIG. 2. In each of these pixel region 41, a P-type P-SiTFT 30 for pixel switching is formed. The TFT 30 has a multi-gate structure, which makes it possible to reduce a drain-source voltage applied to one TFT of the TFTs 30, as compared with one using a single-gate structure. Furthermore, in the present exemplary embodiment, the drain introducing an impurity into the semiconductor layer of the P-SiTFT 30 has the LDD (Lightly Doped Drain) structure.

Scanning lines 3a are electrically connected to a plurality of gate electrodes 32 and 33 of the TFTs 30. Pulse type scanning signals G1, G2, . . . , Gm are applied in this order and line-sequentially from the scanning lines 3a at predetermined timings. Data lines 6a are electrically connected to the sources of the TFTs 30 to supply image signals S1, S2, . . . , Sn in one scanning period. The image signals S1, S2, . . . , Sn to be written to the data lines 6a may be supplied according to a method in which they are sequentially supplied in this order (point-sequential drive) or a method in which data is simultaneously supplied in a batch (line-sequential drive) or for each group (selector switch) to a plurality of adjoining data lines 6a.

A pixel electrode 9 is electrically connected to the drain of each TFT 30 so that the image signals S1, S2, . . . , Sn supplied from a data line 6a are written to each pixel at a predetermined timing in one scanning period. The image signals S1, S2, . . . , Sn of a predetermined level written to a liquid crystal through the pixel electrode 9 as describe above are retained for a predetermined period between the liquid crystal and a common electrode 21 of the opposing substrate 20 shown in FIG. 1(b). To reduce or prevent the retained image signals S1, S2, . . . , Sn from leaking, a storage capacitor 60 is added in parallel to the liquid crystal capacitor formed between the pixel electrode 9 and the common electrode 21.

Detailed Configuration of Pixels

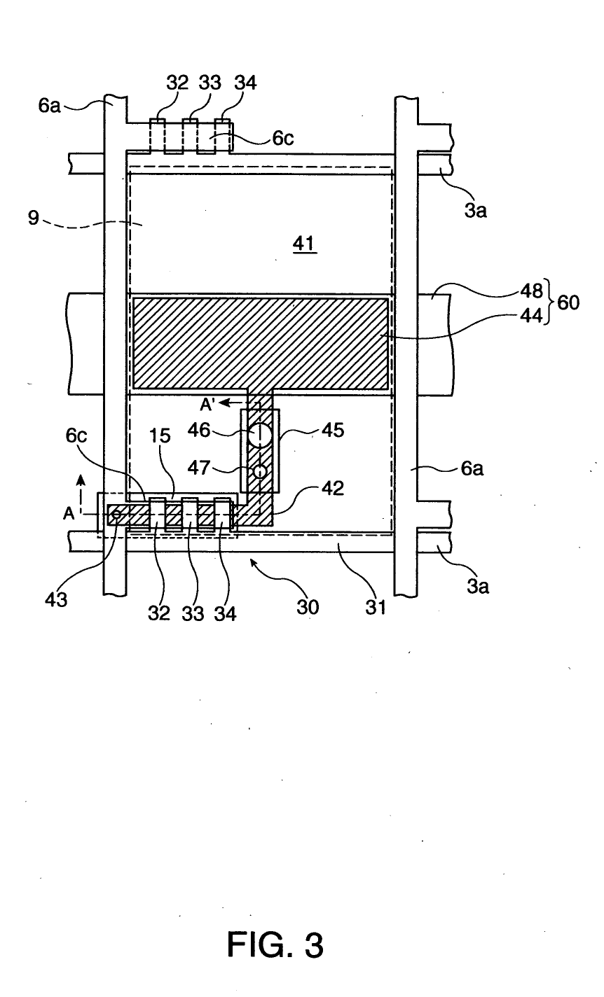

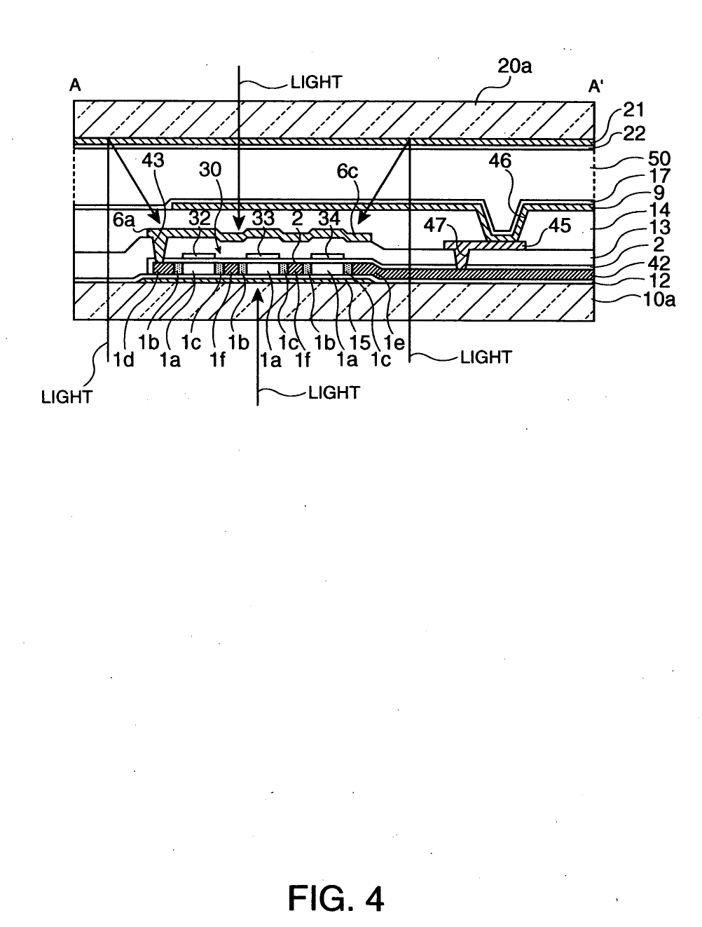

FIG. 3 shows a top plan view of one pixel region on the TFT array substrate 10 constituting a liquid crystal device according to the present exemplary embodiment. FIG. 4 is a sectional view taken along plane A-A′ shown in FIG. 3.

As shown in FIG. 3, the data lines 6a and the scanning lines 3a are provided on the TFT array substrate such that they intersect with each other. The semiconductor layers 42, which are substantially L-shaped as observed from above, are provided in the substantially rectangular pixel regions 41 defined by the data lines 6a and the scanning lines 3a. Each of the scanning lines 3a has a scanning line mainline portion 31 extending in a direction in which it intersects with the data lines 6a and a plurality of (three in FIG. 3) gate electrodes (scanning line branched portions) 32 through 34 extended from the mainline portion 31 toward the center of the pixel region 41. The gate electrodes 32 through 34 intersect with the portions of the semiconductor layer 42 that extend in parallel to the scanning line mainline portion 31, thus forming a triple-gate TFT. One end of the substantially L-shaped semiconductor layer 42 is electrically connected to the data line 6a through a source contact hole 43, while the other end thereof is extended substantially to the center of the pixel region 41 to constitute a capacitance electrode 44, which is substantially rectangular as observed from above and integrally formed with the semiconductor layer 42. The storage capacitor 60 is formed in the portion wherein the capacitance electrode 44 and a capacitance line 48 extending in parallel to the scanning line mainline portion 31 planarly overlap each other.

The pixel electrode 9, formed in the planar region nearly overlapping the pixel region 41, is made of a transparent conductive material, such as ITO, and electrically connected through a relay conductive layer 45 to the portion of the semiconductor layer 42 that vertically extends in the figure. The pixel electrode 9 and the relay conductive layer 45 are electrically connected through a pixel contact hole 46. The relay conductive layer 45 and the semiconductor layer 42 of the TFT 30 are electrically connected through a drain contact hole 47 so as to electrically connect the pixel electrode 9 and the TFT 30.

In the sectional structure shown in FIG. 4, the TFT array substrate 10 includes a light shielding film (light shielding device) 15 formed partly on one surface of a substrate main body 10a made of, for example, quartz, glass, or plastics. The first light shielding film 15 and the substrate main body 10a are covered by a base insulating film 12, and the TFT 30 is provided on the base insulating film 12. The base insulating film 12 functions to isolate the light shielding film 15 and the TFT 30 and to act as a buffer film of a surface of the substrate main body 10a and degradation of the characteristics of the TFT 30 due to contamination or the like.

The TFT 30 has the triple-gate structure, as described above, and also the LDD structure. The TFT 30 is primarily formed of gate electrodes 32 through 34, three channel regions 1a formed in the regions opposing the gate electrode 32 through 34 of the semiconductor layer 42, and a thin insulating film 2 constituting a gate insulating film that isolates the gate electrodes 32 through 34 and the semiconductor layer 42. The TFT 30 further includes a lightly doped source region 1b and a lightly doped drain region 1c formed on both sides of the three channel regions 1a to constitute the LDDs, a highly doped source region id and a highly doped drain region 1e formed on both sides of these LDDs, and highly doped source-drain regions If formed among the channel regions 1a. The semiconductor layer 42 according to the present exemplary embodiment is formed of polysilicon, and boron ions, for example, are implanted in each source-drain region so as to produce the P-type TFT 30.

The highly doped drain region 1e of the semiconductor layer 42 is extended toward the center of the pixel region 41 to form the capacitance electrode 44. The capacitance line 48 formed such that it opposes the capacitance electrode 44, shown in FIG. 3, is formed in the same layer as the scanning lines 3a and constitutes the storage capacitor60 through the intermediary of the thin insulating film 2, shown in FIG. 4.

A first interlayer insulating film 13 is formed to cover the scanning line 3a (and the capacitance line 48). The data line 6a and the relay conductive layer 45 are formed by the same layer on the first interlayer insulating film 13. A data line branched portion 6c is extendedly provided from the data line 6a in the direction in which the scanning line 3a extends, so as to extend to the region covering the gate electrodes 32 through 34, thus forming the light shielding device according to the present exemplary embodiment. The data line 6a and the relay conductive layer 45 are formed using a low-resistance metal, such as A1.

A source contact hole 43 is formed such that it penetrates the first interlayer insulating film 13. The data line 6a and the highly doped source region Id of the semiconductor layer 42 are electrically connected through the source contact hole 43. Furthermore, a drain contact hole 47 is formed such that it penetrates the first interlayer insulating film. The relay conductive layer 45 and the highly doped drain region 1e of the semiconductor layer 42 are electrically connected through the drain contact hole 47.

A second interlayer insulating film 14 is formed such that it covers the data line 6a and the relay conductive layer 45, and a pixel electrode 9 is formed on the second interlayer insulating film 14. The pixel electrode 9 is formed of a transparent conductive material, such as ITO. In a planar region of the relay conductive layer 45, a pixel contact hole 46 is formed such that it penetrates the second interlayer insulating film 14. The pixel electrode 9 and the relay conductive layer 45 are electrically connected through the pixel contact hole 46. With the aforementioned construction, the highly doped drain region 1e of the semiconductor layer 42 and the pixel electrode 9 are electrically connected through the intermediary of the relay conductive layer 45. Although not shown in FIG. 4, an alignment layer formed of a polyimide film or the like, which has been subjected to alignment processing, such as rubbing, is provided on a topmost surface of the TFT array substrate 10.

The opposing substrate 20 has a common electrode 21 formed all over a liquid crystal layer 50 of the substrate main body 20a, and an alignment film 22 formed to cover the common electrode 21. The common electrode 21 can be formed of a transparent conductive material, such as ITO. The alignment film 22 can be formed to have the same configuration as that of the alignment film 17 of the above TFT array substrate 10. To perform color display, a color filter having color material layers, e.g., R (red), G (green), and B (blue), may be formed on the substrate main body 10a or 20a to correspond to the pixel regions 41.

In the liquid crystal device according to the present exemplary embodiment having the aforementioned construction, first, the TFT 30 is provided with the multi-gate structure to reduce the voltages at both sides of one channel region 1a so as to reduce the OFF leakage current.

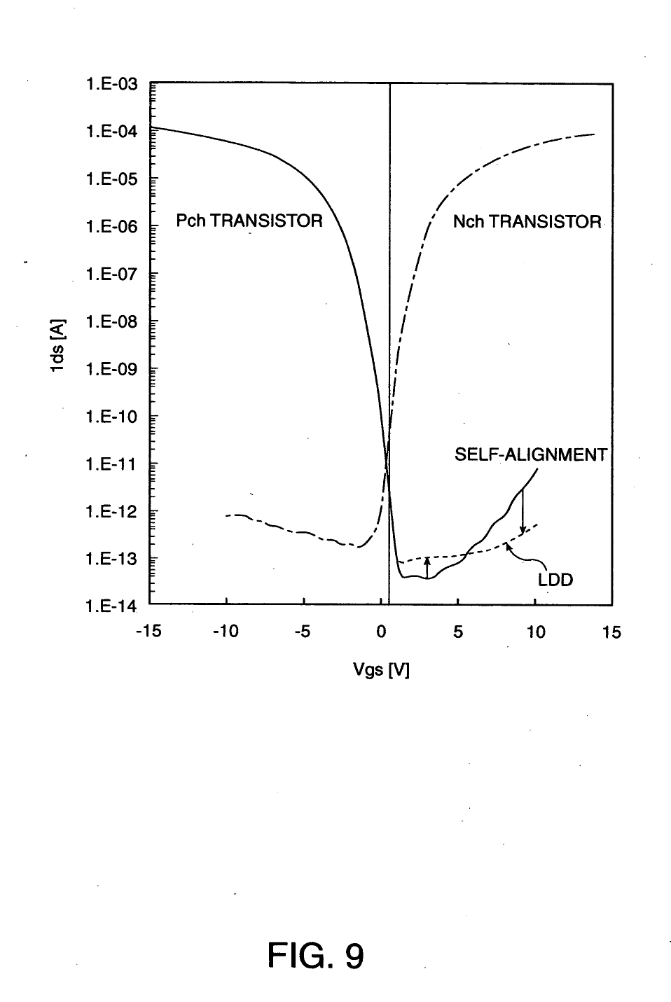

Second, the LDD structure in which the lightly doped source regions 1b and the lightly doped drain regions 1c are provided on both sides of each channel region 1a is used, thus permitting the OFF current to be reduced. FIG. 9 is a graph indicating the operation obtained by introducing the LDD structure. The two curves shown in the graph indicate Id/Vg characteristics of P-type and N-type transistors, respectively. As shown in FIG. 9, the current characteristics on the OFF side in the curve of the P-type transistor can be planarized by providing the transistors with the LDD structure.

Third, the light shielding film 15 is formed on the substrate main body 10a of the TFT 30 to reduce or prevent light from the TFT array substrate 10 from entering the TFT 30. The data line branched portions 6c covering the TFT 30 that are formed by extending a part of the data lines 6a are used as the light shielding device, thereby reducing or preventing light from the liquid crystal layer 50 from entering the TFT 30. This makes it possible to nearly completely block light from entering the TFT 30.

Fourth, the use of P-type transistors for the TFTs 30 reduces dark current. As previously described, in response to a small quantity of incident light, the light leakage current of P-type transistors increases to the same level as that of N-type transistors. In the liquid crystal device according to the present exemplary embodiment, the TFTs 30 can be provided with substantially complete light shielding by the light shielding films 15 and the data line branched portions 6c provided as the light shielding device, so that the feature of the low OFF current inherent in P-type transistors can be utilized.

In an extra-high-definition liquid crystal device of about 500 ppi (500 pixels per 25.4 mm), the sum of a liquid crystal capacity and holding volume of a pixel is extremely small. In such a liquid crystal device, if leakage current of a transistor is large, then the leakage of electric charges makes it impossible to maintain display quality. In the liquid crystal device according to the present exemplary embodiment, all the four operations to reduce leakage current described above are effectively utilized, thus making it possible to reduce the leakage current of the TFTs 30 to an extremely low level. Moreover, it has been made possible to achieve a liquid crystal device with an extra-high definition, which cannot be attained by the related art technologies.

Second Exemplary Embodiment

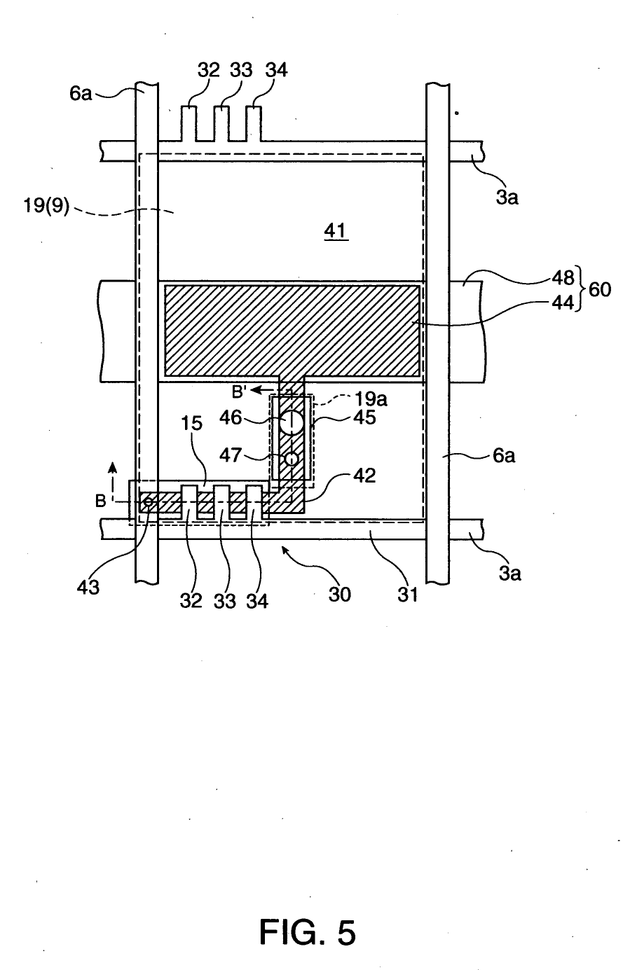

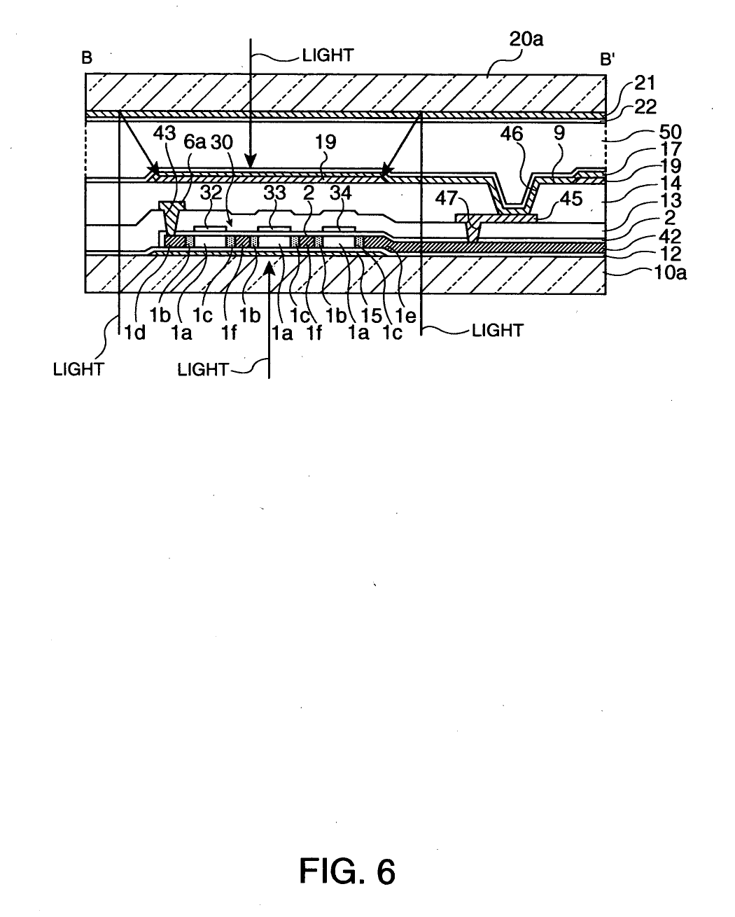

Referring now to FIG. 5 and FIG. 6, a liquid crystal device according to a second exemplary embodiment of the present invention will be explained. FIG. 5 is a top plan view showing one pixel region of a TFT array substrate constituting the liquid crystal device according the present exemplary embodiment. FIG. 6 is a sectional schematic taken along plane B-B′ shown in FIG. 5. Like parts, as those in the aforementioned first exemplary embodiment, will be assigned like reference numerals, and explanation thereof will be omitted.

As shown in FIG. 5 and FIG. 6, in the liquid crystal device according to the present exemplary embodiment, a reflective layer 19 made of a metal material, such as aluminum or silver, is formed on the second interlayer insulating film 14 in the planar region substantially overlapping the pixel region 41. The pixel electrode 9 formed of ITO or the like, is formed such that it covers the reflective layer 19. An opening 19a is formed in the planar region corresponding to the relay conductive layer 45 of the reflective layer 19. The relay conductive layer 45 and the pixel electrode 9 are electrically connected through the pixel contact hole 46. As the sectional structure shown in FIG. 6 indicates, the reflective layer 19 formed to planarly cover the liquid crystal layer 50 of the TFT 30 replaces the data line branched portions 6c provided as the light shielding device adjacent to the liquid crystal layer 50 of the TFT 30 in the first exemplary embodiment. Thus, in the present exemplary embodiment, the reflective layer 19 serves as the light shielding device in accordance with the present invention.

As in the previous first exemplary embodiment, the TFTs 30 in the liquid crystal device according to the present exemplary embodiment also use the P-type transistors having the multi-gate structure and the LDD structure so as to reduce the OFF leakage current. This is combined with the additional operation to restrain an increase in dark current of the P-type transistors by providing the light shielding film 15 and the reflective layer 19 to completely block light into the TFTs 30. Thus, it is possible to achieve considerably reduced leakage current, as compared with related art thin-film transistors, permitting display of higher definition to be easily accomplished.

In addition to the aforesaid advantages, in the liquid crystal device according to the present exemplary embodiment, the reflective layer 19 functioning as the light shielding device adjacent to the liquid crystal layer 50 of the TFTs 30 is formed apart from the semiconductor layer 42, as compared with the data line branched portion 6c in the first exemplary embodiment. This arrangement makes it difficult for capacitive coupling to take place between the gate electrodes 32 through 34 of the TFT 30 and the reflective layer 19 functioning as the light shielding device. Therefore, the TFTs 30 are less susceptible to influences caused by the capacitive coupling, allowing the drive performance of the TFTs 30 to be substantially enhanced.

Third Exemplary Embodiment

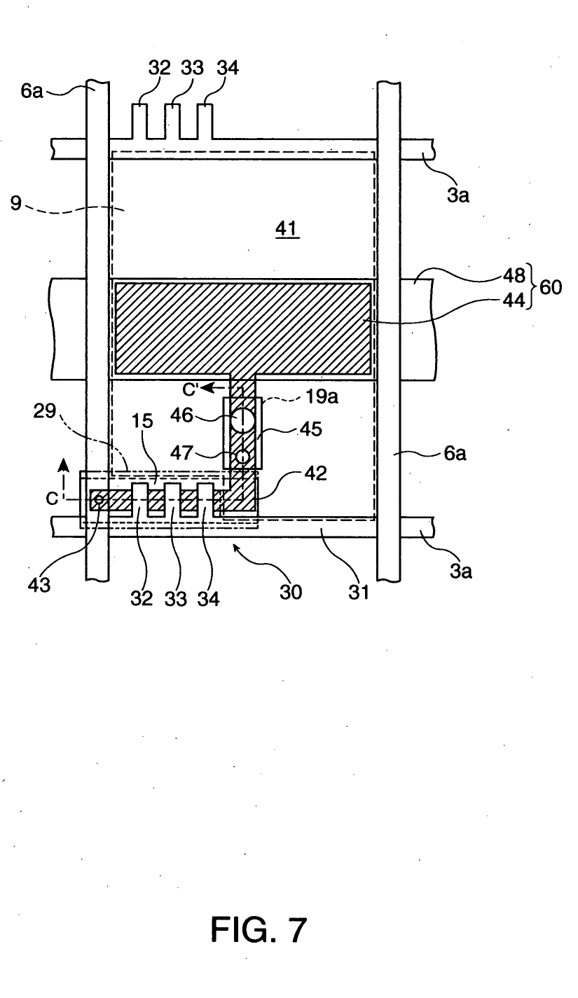

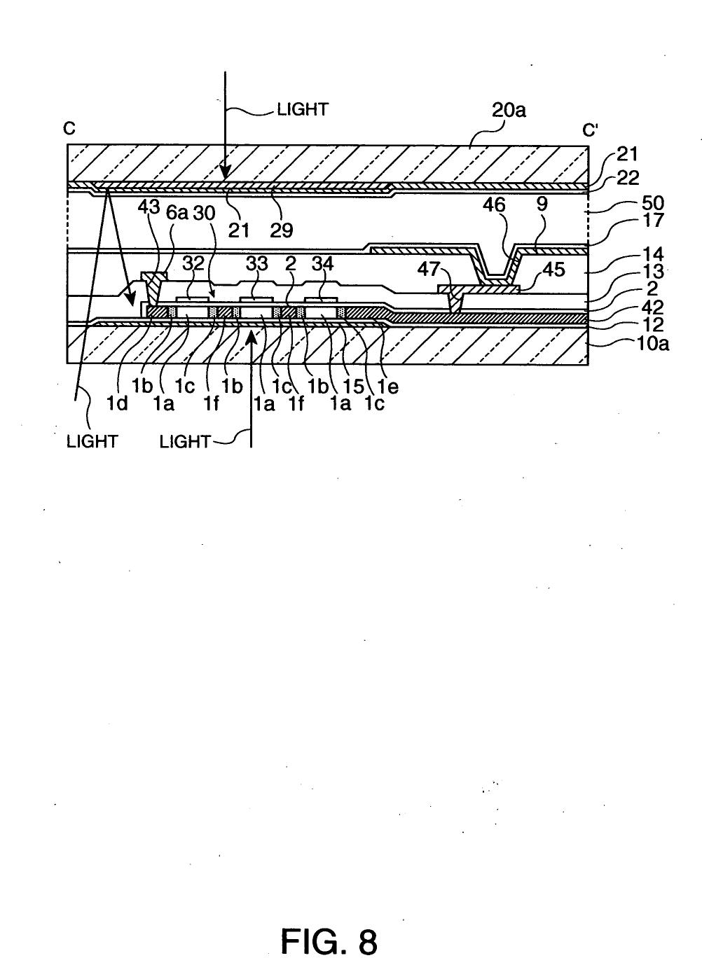

Referring now to FIG. 7 and FIG. 8, a liquid crystal device in accordance with a third exemplary embodiment of the present invention will be explained. FIG. 7 is a schematic showing one pixel region of a TFT array substrate constituting the liquid crystal device according to the present exemplary embodiment. FIG. 8 is a sectional schematic taken along plane C-C′ shown in FIG. 7. Like reference numerals will be assigned to like components in the first exemplary embodiment, and the explanation thereof will be omitted.

As shown in FIG. 7 and FIG. 8, in the liquid crystal device in accordance with the present exemplary embodiment, a light shielding film 29 is formed on the inner surface of an opposing substrate 20. As indicated by a two-dot chain line in FIG. 7, the light shielding film 29 is formed in the planar region, which substantially corresponds to the region wherein a light shielding film 15 is formed, to constitute the light shielding device in the liquid crystal device according to the present exemplary embodiment. The light shielding film 15 provided on the TFT array substrate 10 is formed to planarly cover a portion of a substantially L-shaped semiconductor layer 42 and the angular portion thereof, the portion extending in parallel to scanning lines 3a.

As in the first exemplary embodiment, the TFTs 30 in the liquid crystal device according to the present exemplary embodiment also use the P-type transistors having the multi-gate structure and the LDD structure so as to reduce the OFF leakage current. This is combined with the additional operation to restrain an increase in dark current of the P-type transistors by providing the light shielding film 15 and the light shielding film 29 to completely block light into the TFTs 30. Thus, it is possible to achieve considerably reduced leakage current, as compared with related art thin-film transistors, permitting display of higher definition to be easily accomplished.

In addition to the above advantages, in the liquid crystal device according to the present exemplary embodiment, the light shielding film 15 and the light shielding film 29 functioning as the light shielding device of the TFTs 30 are formed in a larger planar region than that in the first exemplary embodiment. This makes it possible to reduce or prevent the light reflected off the inner surface (the liquid crystal layer 50) of the light shielding film 15 or the light shielding film 29 from entering the TFTs 30 even if the light emitted from a light source (not shown) provided outside the liquid crystal device includes components that are incident upon aslant with respect to the substrate 10 or 20. With this operation, further enhanced light shielding of the TFTs 30 is ensured, making it possible to provide a liquid crystal device that incurs further less light leakage and permits higher definition to be easily achieved.

Projection Type Display Device

An example of a projection type display device equipped with the liquid crystal device described above will now be explained.

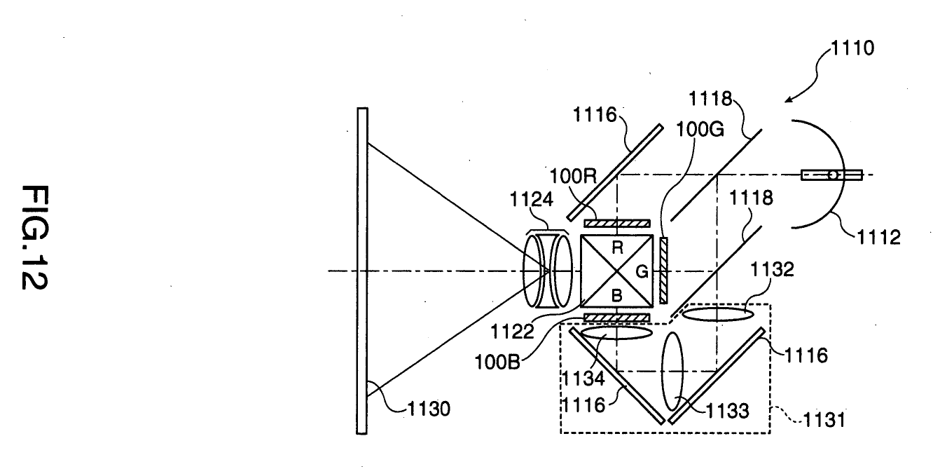

FIG. 12 is a schematic showing a configuration of a projection type display device equipped with the aforementioned liquid crystal device as a light valve. The projection type liquid crystal display device 1110 is constructed as a three-plate type projector using the liquid crystal devices according to the aforesaid exemplary embodiments, as RGB light valves 100R, 10G, and 100B. In this liquid crystal projector 1110, light emitted from a white light source lamp unit 1112 of a metal halide lamp or the like is separated into light components R, G, and B that correspond to three primary colors R, G, and B by three mirrors 1116 and two dichroic mirrors 1118 (light separating device), and then guided to their corresponding light valves 100R, 100G, and 100B (liquid crystal devices/liquid crystal light valves). At this time, the light component B having a longer optical path is guided through the intermediary of a relay lens system 1131 constructed of an incident lens 1132, a relay lens 1133, and an emergent lens 1134 in order to reduce or prevent optical loss. The optical components R, G, and B corresponding to the three primary colors, which have been modulated by the light valves 100R, 100G, and 100B, respectively, are incident upon a dichroic prism 1122 (photosynthesizing device) from three directions to be synthesized again. The resynthesized optical components are enlarged and projected as a color image onto a screen 1130 or the like through a projection lens (projection optical system) 1124.

The use of the liquid crystal devices having their transistor OFF leakage current reduced to an extremely low level enables the projection type display device to achieve display of extra-high definition of 500-ppi class, which could not be achieved in the past.

The present invention is not limited to the exemplary embodiments described above, but intended to cover various modifications within the spirit and scope of the present invention.

For instance, in the aforementioned exemplary embodiments, the examples in which the TFTs have the triple-gate structure. However, the present invention is not limited thereto. The TFTs may have double gates or four gates or more. Furthermore, the shown pattern configurations, sectional structures, materials of the films, etc. are just examples, and may be changed, as necessary.

The active matrix substrate in accordance with an aspect of the present invention can be ideally applied to a display device using, for example, fluorescence or the like by electroluminescence (EL), plasma emission, electron emission, or a display device using a digital micro mirror device (DMD), and electronic equipment provided with these display devices.

What is claimed is:

1. A liquid crystal device, comprising:
an active matrix substrate having a plurality of scanning lines and a plurality of data lines provided such that they intersect each other, thin-film transistors provided in association with intersections of the data lines and the scanning lines, and pixel electrodes connected to the thin-film transistors;
an opposing substrate disposed such that it opposes the active matrix substrate; and
a liquid crystal layer sandwiched between the two substrates;
the thin-film transistors formed of P-type transistors having semiconductor layers, a plurality of gate electrodes intersecting the semiconductor layers at a plurality of locations, LDD portions in which P-type lightly doped regions are formed at least on one side of channel regions of the semiconductor layers, and
a light shielding device provided on both sides in a direction of thickness of the thin-film transistors.

2. The liquid crystal device according to claim 1, the data lines disposed such that they planarly overlap the channel regions of the semiconductor layers so as to form the light shielding means.

3. The liquid crystal device according to claim 1,
the data lines having data line mainline portions extending in a direction in which they intersect the scanning lines and data line branched portions branching from the data line mainline portions in a direction in which they intersect the data line mainline portions, and
the data line branched portions are disposed such that they planarly overlap the channel regions so as to form the light shielding device.

4. The liquid crystal device according to claim 1,
a reflective layer formed on the active matrix substrate to perform reflective display, and
a part of the reflective layer formed such that it planarly overlaps the channel regions of the semiconductor layers so as to constitute the light shielding device.

5. The liquid crystal device according to claim 1,
the scanning lines having scanning line mainline portions extending in a direction in which they intersect the data lines, and a plurality of scanning line branched portions extended in a direction in which they intersect the scanning line mainline portions, and
the scanning line branched portions having the gate electrodes that planarly intersect the semiconductor layers.

6. The liquid crystal device according to claim 1, the semiconductor layers formed of polysilicon or continuous grain silicon.

7. The liquid crystal device according to claim 1, the light shielding device formed on the opposing substrate at a position corresponding to the channel regions.

8. An active matrix substrate, comprising:
a plurality of scanning lines and a plurality of data lines provided such that they intersect each other; and
thin-film transistors provided in association with intersections of the data lines and the scanning lines;
the thin-film transistors formed of P-type transistors having semiconductor layers, a plurality of gate electrodes intersecting the semiconductor layers at a plurality of locations, LDD portions in which P-type lightly doped regions are formed at least on one side of channel regions of the semiconductor layers, and
a light shielding device provided on both sides in a direction of thickness of the thin-film transistors.

9. The active matrix substrate according to claim 8, the data lines disposed such that they planarly overlap the channel regions of the semiconductor layers so as to form the light shielding device.

10. The active matrix substrate according to claim 8, the data lines having data line mainline portions extending in a direction in which they intersect the scanning lines, and data line branched portions branching from the data line mainline portions in a direction in which they intersect the data line mainline portions, and
the data line branched portions are disposed such that they planarly overlap the channel regions so as to form the light shielding device.

11. A display device, comprising:
the active matrix substrate according to claim 8.

12. Electronic equipment, comprising:
the liquid crystal device according to claim 1.
